(19) United States
(12) Patent Application Publication
(10) Pub. No.: US 2016/0019820 A1
(43) Pub. Date: Jan. 21, 2016

(54) DECORATIVE AND PROTECTIVE MOLDED LABEL

(71) Applicant: PWE, LLC, Cumberland, RI (US)

(72) Inventors: Layne Mayer, Cumberland, RI (US); Richard B. Fox, Smithfield, RI (US); Roger LaFlamme, Sturbridge, MA (US)

(21) Appl. No.: 14/743,925

(22) Filed: Jun. 18, 2015

Related U.S. Application Data
(60) Provisional application No. 62/013,822, filed on Jun. 18, 2014.

(51) Int. Cl. G09F 3/02; G09F 3/10

(52) U.S. Cl. CPC G09F 3/02; G09F 3/10; G09F 2003/0264; G09F 2003/0273

(57) ABSTRACT

A decorative molded foam or molded gel protective label configured to partially or entirely encase glass or fragile plastic container. The molded label may be film coated on an exterior facing surface for improved feel. The molded article may be textured and/or have three-dimensional protections for additional protection. The film may include an anti-microbial to protect the user from germs that often get transferred to conventional glass.

### BACKGROUND OF THE INVENTION

1. Field of the Invention

This invention relates to labels and decorative features for fragile containers, e.g., perfume and cosmetic bottles.

### Description of the Background

Perfume and cosmetic bottles, typically formed of fragile glass and/or plastic, are easily broken, subjecting the high value contents to loss and subjecting surrounding objects and materials to soiling. While the bottles are often packed in impact resistant packaging (e.g., foam peanuts, bubble wrap, etc.) for shipping, once the bottles have arrived at a retail location, or at a home for end-use, the packaging material is removed, and the bottle is left unprotected in order to display the decorative shape and/or other features of the bottle. Other than the form/shape/texture of the bottle and top itself and the two-dimensional paper or foil label, there are no decorative features. Additionally, the bottles can be slippery and difficult to hold, especially when wet, and there is nothing to protect them from breakage in the event of impact.

### SUMMARY OF THE INVENTION

The present invention presents a solution to the problems of fragile glass bottle perfume and cosmetic containers which are stripped of protection after shipping to display their decorative shapes and features.

According to the invention, there is presented a decorative molded foam or molded gel protective label configured to partially or entirely encase glass or fragile plastic container

According to various embodiments of the invention, the molded label may be film coated on an exterior facing surface for improved feel. The film may include an anti-microbial to protect the user from germs that often get transferred to conventional glass.

According to other embodiments of the invention, the molded label may have an adhesive backing to allow it to be easily attached to a bottle. According to another embodiment, the molded label may be provided with a film backing over the adhesive, which film may be peeled away from the label when it is ready to be attached to a bottle.

According to another embodiment of the invention, the molded label may have an adhesive of the type that makes the label easily removable from the bottle after it has been attached to the bottle. Therefore, the adhesive backing may be selected and/or configured for permanent/semi-permanent attachment, or for removable attachment of label to bottle to allow for easy recycling of the bottle.

According to further embodiments of the invention, the molded labels may be configured to make a friction-fit to the target bottle, so that no adhesive is necessary.

According to a further embodiment of the invention, the molded labels may cover all or part of the bottom of the bottle in order to provide additional breakage protection.

According to further embodiments of the invention, the molded labels may be configured to have three-dimensional features that are both decorative and shock-absorbent.

According to further embodiments of the invention, the molded labels may have three-dimensional features be configured to match or compliment designs on bottle.

According to further embodiments of the invention, the molded labels may have textured exterior-facing surface.

According to further embodiments of the invention, the molded labels may include anti-microbial agents in the foam or gel material and/or in a surface film to inhibit the growth of microbes.

### BRIEF DESCRIPTION OF THE DRAWINGS

FIG. 1 shows a mockup of a molded foam or molded gel protective label attached to the exterior of a glass bottle according to an embodiment of the invention.

FIG. 2 shows a molded foam protective label attached to the exterior of a glass bottle according to another embodiment of the invention.

FIG. 3 shows a molded foam protective label attached to the exterior of a glass bottle according to another embodiment of the invention.

FIG. 4 shows a molded foam protective label attached to the exterior of a glass bottle according to a further embodiment of the invention.

FIG. 5 shows an example of how a trademark and other three dimensional features may be incorporated into a molded foam protective label according to an embodiment of the invention.

### DETAILED DESCRIPTION

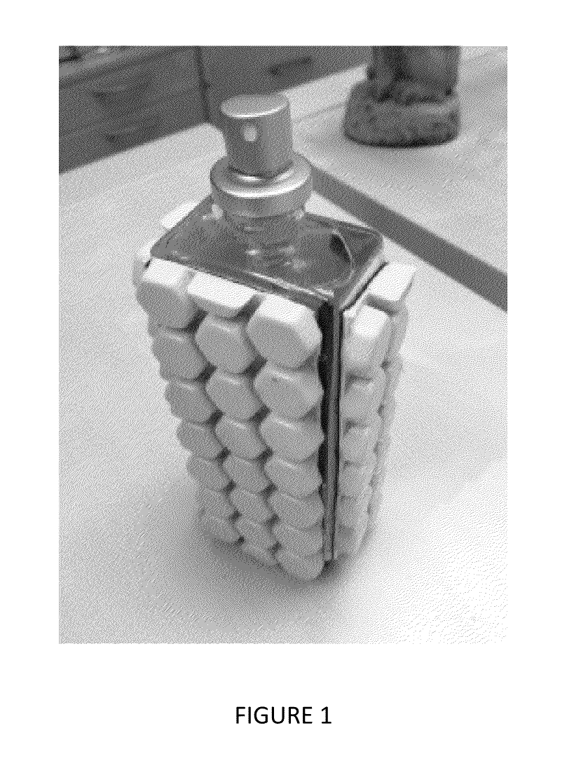

FIG. 1 shows a composite molded foam protective bottle label having a plurality of segments which may be individually attached/adhered to a bottle surface. Each segment has an adhesive backing which allows it to be adhered to a bottle surface. The adhesive backing may be applied directly to the interior facing surface of the article or it may be applied to a film which film is attached to the interior facing surface of the label. According to the embodiment shown in FIG. 1, the article may have integrally molded three-dimensional features on the exterior facing surface of the article, which may have both decorative and protective aspects. According to the embodiment shown in FIG. 1, the molded label may be figured to cover substantially the entire bottle for maximum protective effect.

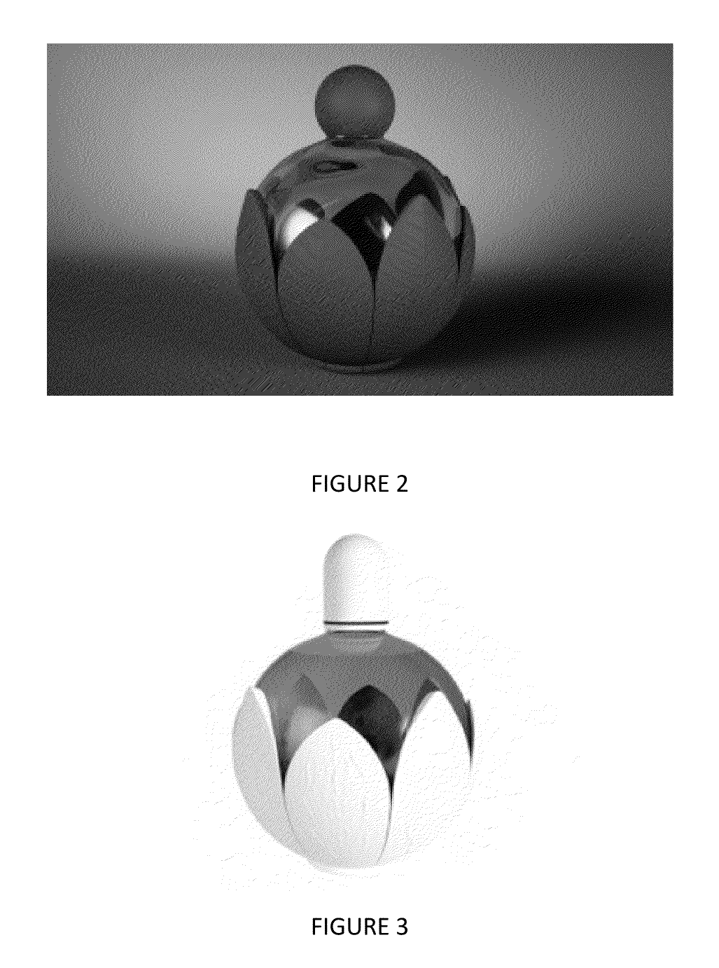

FIGS. 2 and 3 show a molded foam protective bottle label that is configured to match the shape of the bottle providing for a friction fit (optionally not requiring the use of adhesive), and which covers the bottom of the bottle and at least the bottom half of the bottle. The molded foam protective label shown in FIGS. 2 and 3 has a molded textured surface which has both decorative and an improved grip functions, as well as provide an interesting tactile impression (“feel”). According to the embodiments shown in FIGS. 2 and 3, the features which provide texture are preferably less than 2 mm in height, more preferably less than 1 mm in height, measured in a direction perpendicular to the surface of the bottle. According to a preferred embodiment, the molded foam protective bottle label of FIGS. 2 and 3 is a single element which is applied to the bottle as a single unit and which covers approximately one-half to more than one-half of the bottle surface. Optionally, adhesive backing may be applied to all or to just a portion of the molded protective label shown in FIGS. 2 and 3 in order to improve adhesion to the bottle. In addition, the thickness of the article may vary gradually in order to provide improved protection at certain areas of the bottle as well as to provide interesting visual and tactile effect. The shape of the article may be adapted to imitate or evoke natural or fanciful objects and/or to complement bottle design.

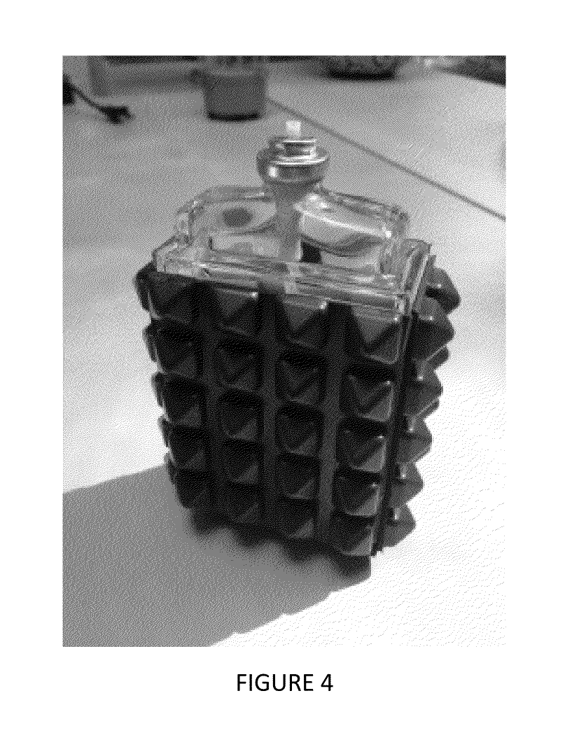

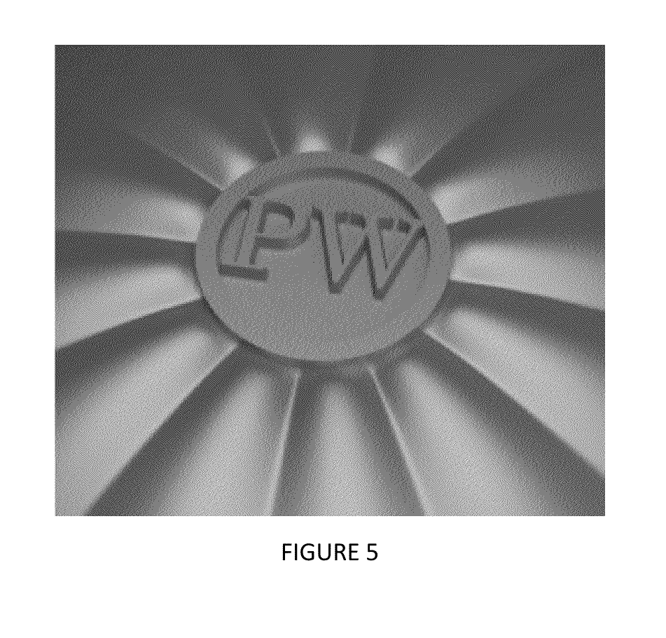

FIG. 4 shows an embodiment similar to the embodiment shown in FIG. 1. As in FIG. 1, the article in FIG. 4 has integrally molded three dimensional features/protrusions. These protective protrusions are preferably 5-20 mm in height, measured in a direction perpendicular to the surface of the bottle.

FIG. 5 shows how product branding may be molded into the article. In addition, product information and other label contents may be printed onto the molded article, either after molding, or during the molding process by use of a preprinted film that that is molded to the molded article as part of the manufacturing process.

The molded foam and molded gel protective labels may be manufactured according to the methods for manufacturing molded foam and gel articles disclosed in U.S. Pat. No. 7,827,704, and U.S. patent application Ser. Nos. 11/644,266; 12/423,174; and 13/008,471, each of which are incorporated herein, in its entirety.

1. A label for a fragile product container, comprising molded foam or molded gel article configured to be adhered or friction fit to the product container.

2. A label according to claim 1, configured to cover the bottom of the product container and more than more than half of the remaining surface of the product container.

3. A label according to claim 1, further comprising a textured exterior-facing surface.

4. A label according to claim 1, further comprising integrally molded three-dimensional projections.

5. A label according to claim 1, further comprising an adhesive applied to an interior facing surface of the label.

6. A label according to claim 5, further comprising a film applied to said adhesive, which film is configured to be peeled away from said adhesive before said label is applied to said container.

7. A label according to claim 1, further comprising integrally molded branding elements.

8. A label according to claim 1, further comprising printed label information.

9. A label according to claim 1, further comprising preprinted film containing product information, integrally molded into said molded article.
